(19) United States
(12) Patent Application Publication
(10) Pub. No.: US 2010/0143642 A1
(43) Pub. Date: Jun. 10, 2010

(54) TEXTILE COMPLEX, COMMUNICATION PANEL, AND METHOD FOR MAKING THE TEXTILE COMPLEX

(76) Inventors: Jean-Philippe Delmotte, Marcy L'Etoile (FR); Eric Bihr, Meys (FR)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/597,854

(22) PCT Filed: May 30, 2008
(86) PCT No.: PCT/FR08/50962

§ 371 Date: Oct. 27, 2009

(30) Foreign Application Priority Data
Jun. 22, 2007 (FR) 0755978

(51) Int. Cl. B32B 3/06; B05D 3/12; B05D 1/00; B05D 3/02

(52) U.S. Cl. 428/99; 427/299; 427/209; 427/314; 427/289; 427/290

(57) ABSTRACT

A textile complex to be applied on a communication panel substrate.

It includes a first layer comprising a non-woven textile web, a first face of said textile web being calendered and a second face comprising loops for interaction with a self-attachment strip fitted with hooks. The textile complex further includes a second layer constituted by a printing ink deposited onto said first layer opposite the first face of the textile web.

### CROSS REFERENCE TO RELATED APPLICATIONS

This application is a National Stage filing under 35 U.S.C. §371 of PCT Application No. PCT/FR2008/050962, filed May 30, 2008. This application also claims the benefit of French Application No. 0755978, filed Jun. 22, 2007. The entirety of both applications is incorporated herein by reference.

### FIELD OF THE INVENTION

The invention relates to the field of wall decorations that can be applied on a substrate, such as wallpaper to cover a wall. Said wall decorations are generally sold in supermarkets and bought directly by private individuals wishing to change the atmosphere and decoration of the interior of their living space.

Said invention also belongs to the field of display bills for use particularly in advertising and more particularly to the field of holding a display bill in position on a display panel substrate. Such display bills are generally made out of a textile material which may or may not be coated, and are applied on the display panel substrate by different methods and particularly by bonding or by tensioning the selvedges of the display bill by adding a trim that engages with an integral groove of the panel.

Hereinafter, the term display bill will be used to denote both an interior wall decoration, such as wallpaper or a poster and a means of advertising. The term communication panel substrate denotes for its part the wall or the frame on which the display bill is applied.

### BACKGROUND OF THE INVENTION

Generally speaking, display bills are made out of paper and are pasted onto a wall or a substrate. Prior to being pasted, they are stored and transported folded or rolled up, which may cause unsightly folds to form on the surface of the display bill. Furthermore, said pasting method needs great skill on the part of the person who has to put the display bill into position on the display panel or on the wall. Indeed, the display bill may come in the form of a plurality of juxtaposed sheets each with the dimensions 2×1.5 m or of rolled widths 0.5 m wide. It frequently occurs therefore that display bills are damaged or remain wrongly positioned on their substrate or walls when put up using this pasting method.

The method is also known of using a display bill constituted by a coated fabric cloth applied on a display panel substrate. In this case, it is possible to place a peripheral trim on the selvedges of the display bill and then to insert said trim inside a groove of the panel in order to tension the cloth. However, a display bill of this kind is complex to produce since it does not allow any significant tolerance in terms of either the make-up rating of the cloth or the placing of the trim on the selvedges of the cloth.

The purpose of the invention is thus to provide a textile complex, in order in particular to constitute a display bill that can be repositioned on a substrate if a positioning error occurs.

Another objective is to avoid the presence of folds on the surface of the display bill even when it is packaged folded before being positioned on the display panel substrate.

It must not require a make-up operation and must allow any person to position it on a communication panel substrate.

### SUMMARY OF THE INVENTION

The invention therefore relates to a textile complex to be applied on a communication panel substrate.

According to the invention, this textile complex is characterized in that it comprises:
a first layer comprising a non-woven textile web, a first face of this textile web being calendered and a second face comprising loops for interaction with a self-attachment strip fitted with hooks;
a second layer constituted by a printing ink deposited onto the first layer opposite the first face of the textile web.

In other words, this textile complex is formed by stacking two layers of different materials. The first layer acts as a substrate to the second layer deposited using an ink jet spraying or sublimation method particularly. By way of example, UV inks can be used and be deposited directly onto the calendered face of the textile web. The first layer therefore comprises a non-woven textile web comprising loops on one of its faces so as to produce a loop and hook assembly and hold the display bill in position on a display panel substrate or a wall. A textile complex of this kind therefore comprises loops distributed over the entire surface of one of its faces, thereby simplifying operations to put up a display bill in the absence of adhesive, but also operations to make-up said display bill since it is not necessary to apply a self-attachment strip fitted with loops or hooks on one of its faces.

Furthermore, a textile complex of this kind has an intrinsic elasticity which means it can be put up with slight tension to give a rendering that is free from folds. This complex may be cut using a pair of scissors or a Stanley knife causing only very slight fraying on the selvedges of the textile web.

To advantage, the first layer may comprise a finish deposited onto the first calendered face of the textile web. In this case, the second layer is deposited onto the finish covering the textile web. Said finish may come in different forms and particularly in the form of a layer of coating or of pulverized particles but also in the form of a film laminated on the textile web.

In practice, the textile web may be formed out of a felt consisting of needled polyester filaments. The textile web thus comprises loops formed of polyester filaments. Said felt may in particular be reinforced mechanically using needles.

According to a particular embodiment, the finish may comprise an acrylic and/or polyurethane base. Said material thereby gives the complex crease-resistance qualities, due in particular to the elastomer content of said finish. The non-woven textile web thus has an elasticity that allows the folds not to be memorized, thereby allowing the textile complex to be delivered folded.

Furthermore, said finish can be used to give good printability particularly with solvent-based ink jet printing.

The invention also relates to a communication panel which is characterized in that it comprises a textile complex as previously described which is applied on a substrate provided with at least one self-attachment strip fitted with hooks that interact with the loops of the second face of the textile web.

In other words, the communication panel comprises a substrate which may be plane, concave, convex, or of any shape on which self-attachment strips are applied so as to self-attach to the textile complex comprising loops on one of its faces. The self-attachment strip may be secured to the communication panel substrate by different fastening means or techniques and in particular by bonding, nailing, stapling, sewing, welding.

A communication panel of this kind thus allows changes to be made particularly to interior decoration or advertising campaigns very quickly and does not damage the display bill once it is disassembled from the substrate. It may therefore be subsequently repositioned on another substrate.

The invention also relates to the method for making a textile complex to be applied on a communication panel substrate.

According to the invention, said making method is characterized in that it comprises the steps of:
calendering a first face of a non-woven textile web constituting an element of a first layer, a second face of this textile web comprising loops for interaction with a self-attachment strip fitted with hooks;
depositing a printing ink constituting a second layer onto the first layer opposite the first face of the textile web.

In other words, the making method comprises using a non-woven textile web, calendering one of its faces and then depositing a printing ink directly or indirectly onto the calendered face. The other face retains the appearance of the non-woven and has loops intended to constitute a loop and hook assembly with a self-attachment strip fitted with hooks.

To advantage, the method may comprise a step of depositing a finish onto the first calendered face of the textile web and constituting another element of the first layer. In this case, a finish and then a printing ink are deposited successively onto the textile web. Said ink may in particular be of the solvent type.

According to one particular embodiment, the step of calendering the first face of the textile web is performed hot. To do this, the textile web is rolled along without sliding in contact with rollers that allow the textile web to be kept taut when in contact with the heated calendering roller.

In practice, the making method may comprise a step of cutting at least one selvedge of the textile web.

In other words, the selvedges of the textile web may be cut during the process of making the textile complex so as to avoid the presence of randomly oriented filaments on the selvedges of the textile web.

According to one particular embodiment, the selvedge may be cut prior to the step of depositing the printing ink. Indeed, the presence of filaments on the selvedges might constrict the print heads during the third step in the method of depositing a printing ink onto the finish.

To advantage, the selvedge may be cut hot. In this way, the filaments on the selvedge of the textile web are bonded to each other and do not emerge from the plane defined by the non-woven textile web.

### BRIEF DESCRIPTION OF THE DRAWINGS

The inventive implementation and the resulting advantages will become clearer from the following embodiment, as supported by the appended figures, wherein:

FIG. 1 is a transverse cross-section view of a textile web in accordance with the invention;

FIG. 2 is a front view of a display panel provided with a textile complex in accordance with the invention.

### DETAILED DESCRIPTION OF THE INVENTION

As already mentioned, the invention relates to a textile complex and a display panel provided with such a complex.

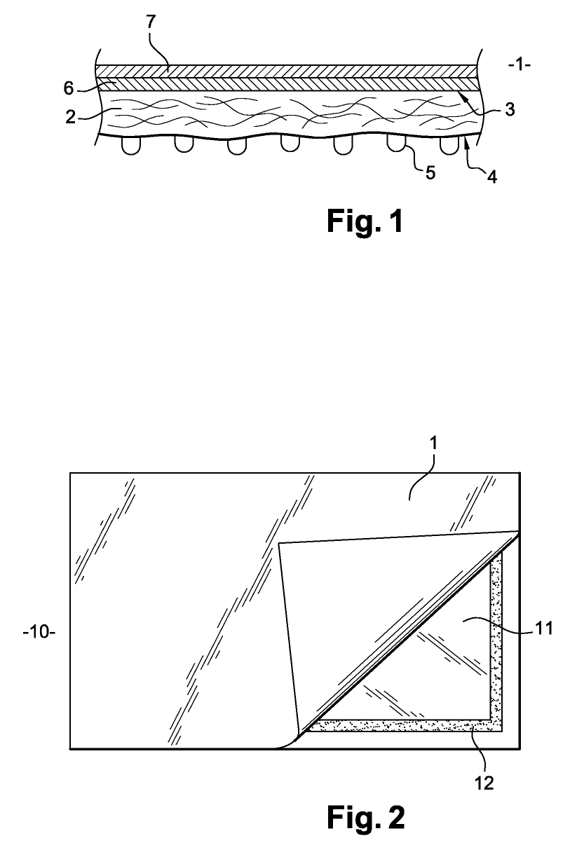

As shown in FIG. 1, the textile complex 1 comprises a first layer constituted by a non-woven textile web 2 such as, in particular, felt. A first face 3 of this textile web 2 is hot calendered and can then be covered with a finish 6, and then with a second layer 7 formed by a printing ink.

A second face 4 of the textile web 2 comprises for its part loops 5 so as to produce a loop and hook assembly with a self-attachment strip fitted with hooks.

As shown in FIG. 2, the invention also relates to a communication panel 10. Said panel comprises a substrate 11 provided with at least one self-attachment strip 12. In the alternative shown, said strip is provided on the edge of the substrate 11 in order to tension the textile complex 1 over the entire surface thereof. As shown, the textile complex 1 is positioned onto the substrate 11 and is automatically held in position by means of the self-attachment strip 12 fitted with hooks and interacting with the loops 5 of the textile complex 1.

It is clear from what has been said above that a complex, a display panel and a method for making the textile complex in accordance with the invention, comprise manifold advantages and in particular:
the complex has an elasticity allowing it to be positioned under tension onto a display panel substrate;
the textile complex is crease-resistant, thereby allowing it to be transported and packaged folded;
the complex has an opacity so that any unevenness of the substrate to which it is secured can be masked;
it is easy to cut using a pair of scissors or a Stanley knife in particular;
it requires no making-up after printing, except for an approximate rating;
installing said complex is very easy and within everyone's reach;
it may be fire resistance treated and particularly under the M1 classification depending on the materials used;
it allows large widths of between 3 and 5 m to be worked easily thereby significantly reducing the amount of matching at installation for large surfaces, and allowing most sizes in use to be handled in a single piece.

1. A textile complex to be applied on a communication panel substrate the complex comprising:
a first layer comprising a non-woven textile web, a first face of said textile web being calendered and a second face comprising loops for interaction with a self-attachment strip fitted with hooks;
a second layer constituted by a printing ink deposited onto said first layer opposite the first face of the textile web.

2. The textile complex as claimed in claim 1, wherein the first layer comprises a finish deposited onto said first calendered face of the textile web.

3. The textile complex as claimed in claim 1, wherein the textile web is formed from a felt consisting of needled polyester filaments.

4. The textile complex as claimed in claim 2, wherein the finish comprises an acrylic and/or polyurethane base.

5. A communication panel comprising a textile complex as claimed in claim 1 applied on a substrate provided with at least one self-attachment strip fitted with hooks interacting with the loops of the second face of the textile web.

6. A method for making a textile complex to be applied on a communication panel substrate, the method comprising the steps of:
calendering a first face of a non-woven textile web constituting an element of a first layer, a second face of said textile web comprising loops for interaction with a self-attachment strip fitted with hooks;
depositing a printing ink constituting a second layer onto said first layer opposite the first face of the textile web.

7. The method as claimed in claim 6, further comprising depositing a finish onto said first calendered face of the textile web and constituting another element of the first layer.

8. The method as claimed in claim 6, wherein the step of calendering the first face of the textile web is performed hot.

9. The method as claimed in claim 6, further comprising a step of cutting at least one selvedge of the textile web.

10. The method as claimed in claim 9, wherein the at least one selvedge is cut prior to the step of depositing the printing ink.
